(19) United States
(12) Patent Application Publication
(10) Pub. No.: US 2011/0043858 A1
(43) Pub. Date: Feb. 24, 2011

(54) IMAGE TRANSFER IDENTIFICATION SYSTEM

(76) Inventor: Paul Jetter, Newton, NJ (US)

Correspondence Address: STEVEN B. STEIN, 114 OLD BLOOMFIELD AVENUE, PARSIPPANY, NJ, 07054, US

(21) Appl. No.: 12/917,060

(22) Filed: Nov. 1, 2010

Related U.S. Application Data
(63) Continuation-in-part of application No. 12/335,042, filed on Dec. 15, 2008.

(51) Int. Cl. G06F 15/00; G06F 17/30

(52) U.S. Cl. 358/1.15; 707/812; 707/E17.044

(57) ABSTRACT

The present invention provides A method for identifying lost individuals comprising the steps of (a) compiling a first individual data contact; (b) entering the first individual data contact sheet information into a computer mediated contact database; (c) compiling a first individual tag identifier; (d) entering the first individual tag identifier into the computer mediated contact database; (e) relating the first individual tag identifier with the individual data contact; and (f) processing the first individual tag identifier onto image transferable media.

The present application claims priority to U.S. Provisional Application Ser. No. 61/014,220, filed on Dec. 17, 2007, and Provisional Application Ser. No. 61/022,372, filed on Jan. 21, 2008, and Non-Provisional application Ser. No. 12/335,042, filed on Dec. 15, 2008, each of which is incorporated by reference in its entirety.

### FIELD OF THE INVENTION

The present invention involves the field of identification marking systems in general and specifically relates to image transfer-based identification system.

The present invention purports to have solved the long-standing problem of identifying lost or disoriented individuals such as lost children or those afflicted by Alzheimer's Disease by use of an image transfer based identification system.

### BACKGROUND OF THE INVENTION

Alzheimer's disease is a neurodegenerative disease affecting more than 24 million people worldwide that affects a patient's ability to recognize familiar places and faces. Other forms of dementia also contribute to a patient's tendency to become disoriented, “wander” away and become “lost.” Most dementia patients do indeed wander off at some time or another. This is particularly troubling because if not found within 24 hours, half of those who wander risk serious injury or death. Similarly, young children that wander off and are not oriented to their surroundings can become lost.

Thus, wandering is among the biggest challenges caregivers and parents face.

The present invention involves the field of identification marking systems in general and specifically relates to image transfer-based identification system. In particular, the invention relates to providing a system for identifying lost individuals. According to a preferred embodiment of the method, the invention provides a heat transfer (iron-on) label integrating specific identification information for an individual, suitable for transfer to a garment. According to a preferred embodiment of the invention, the label comprises a visual representation of the individual. According to another preferred embodiment of the method, the label comprises a unique identifier. According to an embodiment of this invention, the unique identifier is computer generated by a user. According to another embodiment of this invention, the unique identifier is capable of electronically transmitting identification information. According to a preferred embodiment of this invention, the invention further comprises a computer chip. According to a most preferred embodiment of this invention, the invention further comprises a device capable of transmitting a wireless signal. According to another most preferred embodiment of this invention, the invention further comprises an RFID device. According to another preferred embodiment of this invention, the invention further comprises a GPS device. According to still another most preferred embodiment of this invention, the invention further comprises a scanable code such as a bar code or QR Code.

The present invention purports to have solved the long-standing problem of identifying lost or disoriented individuals such as lost children or those afflicted by Alzheimer's disease.

The use of image transfer-based identification labels is well described in the prior art. Moreover, such “tags” are well described for identifying lost individuals. Still further, such heat transfer (iron-on) labels integrating specific identification information for an individual suitable for transfer to a garment are known in the prior art. Such identifier tags are known to include unique identifiers such as bar codes, UPC labels and system generated identification numbers. Also known in the prior art are inventory control systems utilizing identification transmitting devices. Such devices include RFID, Bluetooth and wireless radio transmitters. The present invention specifically contemplates the use of QR codes and any other scan-capable image code.

The prior art also describes various methods for identifying lost children and Alzheimer's patients. Indeed, the Alzheimer's Association “Safe Return” program provides for iron-on transfer labels comprising a unique identifier label maintained in a central database. Numerous examples of “lost children” tags, including iron-on labels, are known in the prior art.

However, a number of problems arise in the prior art methods and devices, including difficulties in properly identifying “lost” individuals and connecting those lost with those who are looking for them. This can be particularly important when the lost individual is unable or unwilling to communicate when found. Even more critical is when the lost individual doesn't realize that they are “lost.”

Many bracelet-type and tag type identifiers are inadequate where an individual is reluctant to wear the device or may remove the device. Furthermore, dedicated systems can be cumbersome, easily lost and expensive.

Thus, there is a great need for an identification system that is easy to use, cost-effective and easily tailored for an individual. Moreover, there is a need for a system that will ease the identification of lost individuals with their proper contacts in a way which preserves their privacy.

The present invention provides distinct advantages over the prior art and solves numerous problems described and understood in the field.

### SUMMARY OF THE INVENTION

It is therefore an object of the present invention to provide a method for identifying lost individuals comprising the steps of (a) compiling a first individual data contact; (b) entering the first individual data contact sheet information into a computer mediated contact database; (c) compiling a first individual tag identifier; (d) entering the first individual tag identifier into the computer mediated contact database; (e) relating the first individual tag identifier with the individual data contact; and (f) processing the first individual tag identifier onto an image transferable media.

### BRIEF DESCRIPTION OF THE DRAWINGS

FIG. 1 shows a flow chart example of use of, the method of the present invention.

FIG. 2 shows an example of printed image transfer media of the present invention

### DETAILED DESCRIPTION OF THE INVENTION

The present invention provides a method for identifying lost individuals comprising the steps of (a) compiling a first individual data contact; (b) entering the first individual data contact sheet information into a computer mediated contact database; (c) compiling a first individual tag identifier; (d) entering the first individual tag identifier into the computer mediated contact database; (e) relating the first individual tag identifier with the individual data contact; and (f) processing the first individual tag identifier onto image transferable media.

According to one embodiment, the method of the present invention further comprises the step of applying the image transferable media onto a garment. It will be understood by those of skill in the art, that such image transfer of the media onto a garment can be accomplished in numerous ways. Most simply, a heat generating device is used to transfer the media to the garment. According to a preferred embodiment of the present invention, the heat generating device is an iron. Alternatively, a heat transfer press is used. The present invention also contemplates use of a steam generator. According to another alternative embodiment, a low temperature pressure generator is used. According to still another embodiment, a vacuum generator is employed.

Image transfer media or heat transfer media is well known to those of skill in the art. Generally, image transfer media is a specialty paper wherein one side of the paper comprises a reverse printed image that is transferred from the paper to a piece of fabric (such as in a garment) when heat (“heat transfer media”) or pressure is applied to the non-printed side of the paper and the printed side is simultaneously placed in contact with the fabric.

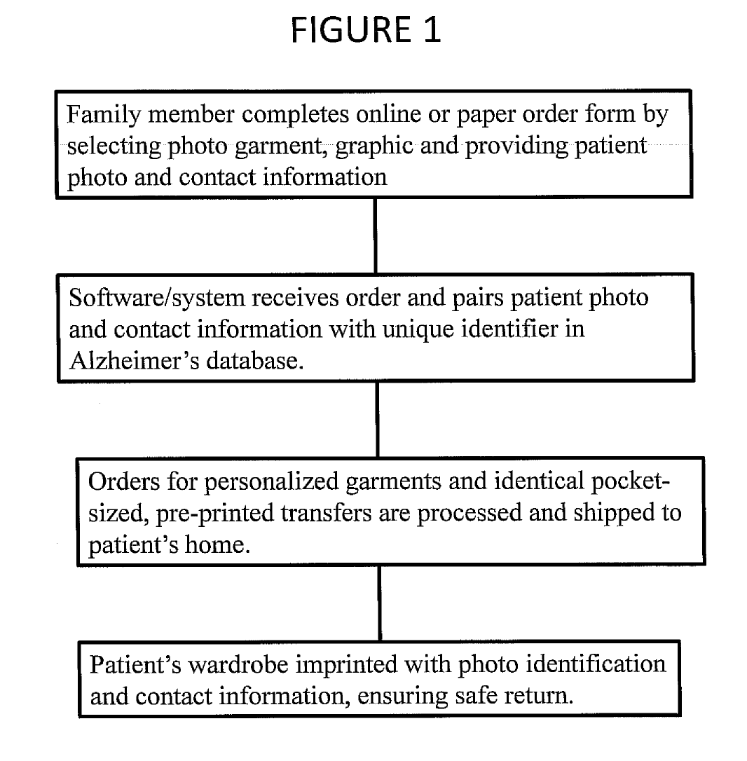

According to one embodiment of the present invention, an ordinary user prints an image onto the image transfer media. According to an alternate embodiment of this invention, the image is professionally printed onto image transfer media. In either case, printed image transfer media can be transferred onto fabric such as in a garment. For example, FIG. 1 shows a flow chart of the present method.

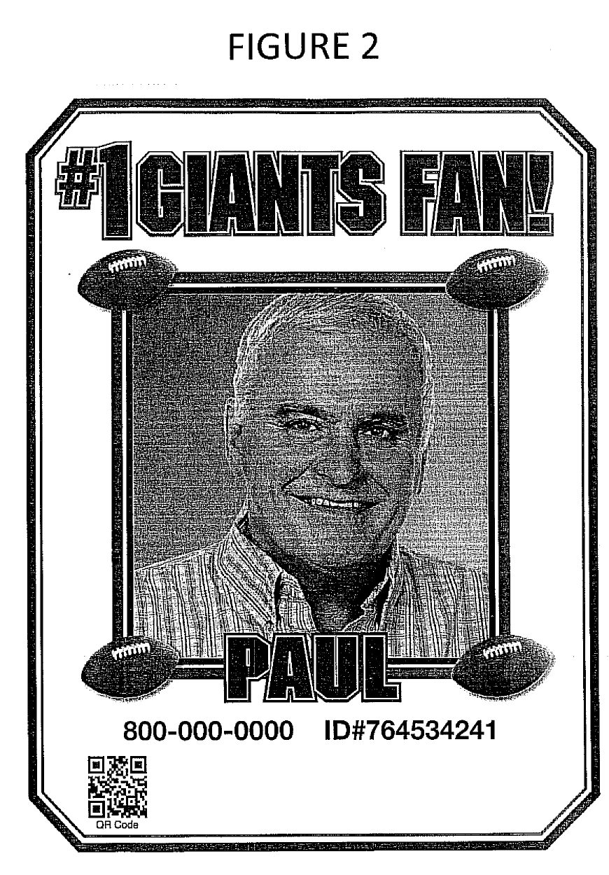

The present invention provides a user with the ability to apply identification information directly onto a garment worn by an individual at risk of wandering or becoming lost. For example, an Alzheimer's patient may be reluctant to wear an identification bracelet or carry an identification card. However, such an individual may be inclined to wear a particular garment with a favorite image (including his own). For example, FIG. 2 shows an image transfer sheet showing an individual identified as a “Number 1 Fan” of a sports team. The sheet also includes an individual identification number, and the name of a centralized telephone contact number. According to an embodiment of the present invention, the individual identification tag can be in the form of a bar code, a computer readable code, a telephone number, or other image linked to a centralized database containing the individual's emergency contact information. According to another embodiment, additional medical information is included. According to still another embodiment, the data base is remotely maintained. According to still another embodiment, the data base is remotely accessed.

According to another embodiment of the present invention, the image transfer media or heat transfer media (collectively “transferable media”) further comprises an RFID device.

RFID is the acronym for “radio frequency identification.” These are electronic devices that consist essentially of a small computer chip and a transmitting antenna. The RFID device serves as an unique identifier tag. Alternatively a magnetic strip could be used. An RFID tag has a distinct advantage for this invention over other methods because the RFID signal can be detected at a distance, albeit a short distance, thereby facilitating the handling of a lost, but agitated individual. RFID technology is also extremely cost effective. In combination with the image transfer media described by the present invention, “iron-on” RFID media greatly facilitates the solutions of the present invention to the problems of the prior art.

GPS is an acronym for Global Positioning System, which is a satellite-based navigation system, capable of determining position anywhere in the world. Some GPS receivers can transmit position information in order to relay position information to another user or data center.

According to another most preferred embodiment of this invention, the invention further comprises a scan-capable code such as a bar code or QR Code. A QR, or “quick response” Code is a matrix barcode (or two-dimensional code), readable by QR scanners, mobile phones with a camera, and smart phones. The code consists of black modules arranged in a square pattern on white background. The information encoded can be text, URL or other data. QR Code generators are well known in the art as are QR Code readers/scanners.

QR Codes are capable of storing addresses and other identifying information and can be stamped or printed on many surfaces including fabric. QR Codes can be read with appropriate scanners or even with modern smart phone applications Users with a camera phone equipped with the correct reader application can scan the image of the QR Code to display text, contact information, connect to a wireless network, or open a web page in the phone's browser. This act of linking from physical world objects is known as a hard link or physical world hyperlinks. Codes can be used in a number of ways, to display text to the user, to add a v-card contact to the users device, to open a URI or to compose a text message or email. Users can also generate and print their own QR Code.

It is specifically contemplated that the QR code can serve as a tag-identifier as described herein. According to one example, it is specifically contemplated that the ubiquitous presence of so-called smart phone QR code scanners/readers, can be used to read identifying information from a QR code printed or stamped on a wearer's apparel, thereby identifying a lost individual. According to a preferred embodiment, the image transferable media further comprises at least one QR Code.

According to another embodiment of the present invention, the first individual contact is compiled remotely through a computer connection. According to yet another embodiment, the first individual tag identifier is compiled remotely through a computer connection. It will be understood by one of skill in the art that use of the Internet greatly facilitates the centralization of data compilation. For example a user enters the contact and identifier information for an individual through an online computer connection such as a secure website, where the data for that individual is stored in a database. Software provided by the site or provided by the kit of the present invention facilitates the generation as well as the compilation and storage of image and identification data.

According to still another embodiment of the present invention, the processing step constitutes printing the first individual tag identifier onto transferable media. The individual tag identifier will be understood by one of skill in the art to include any unique or identifying marks, such as a unique number or alphanumeric sequence, a bar code, a computer readable image, a human readable image, a photographic image or combination of words and images. According to a most preferred embodiment, the identifier comprises a unique radio signal transmitted from an embedded RFID device. According to another preferred embodiment of this invention, the invention further comprises a GPS device. According to one embodiment of this invention, the GPS is capable of transmitting position information to another user or data center. According to still another embodiment, the invention further comprises at least one QR Code. According to another preferred embodiment of the present invention, the printing comprises a photographic image of the individual. According to one embodiment, an end user prints the image. Yet according to another embodiment, the image is printed by a professional printer. According to a preferred embodiment of the present invention, the image transferable media is heat transferable media. According to this embodiment, the heat transferable media is applied using an iron. According to another preferred embodiment of the present invention, the image transferable media further comprises an embedded RFID device.

The present invention also provides a kit for performing the provided, wherein the kit comprises (a) image transferable media; (b) a first individual data contact sheet; and (c) a first individual tag identifier sheet. According to one embodiment of this invention, the image transferable media further comprises an RFID device. According to still another embodiment of this invention, the kit is further comprising an RFID receiving device. According to yet still another embodiment of this invention, the kits is further comprising a computer software program capable of generating a first individual tag identifier image. According to yet another embodiment, the image transferable media further comprises a QR Code generator.

Turning now to the figures. FIG. 1 shows an example of use of the method, wherein a family member of an individual who is a wander risk completes an online or paper order form, thereby compiling contact and photographic information (data contact) for the individual and selects a photo garment and graphic (tag identifier). A software system receives the information and pairs patient photo and contact information with unique identifier in a centralized database, thereby relating the tag identifier with the contact data. Image transfer media is processed (i.e. printed) with the tag identifier and affixed to selected garments. Additional printed image transfer media (i.e. iron-on transfers) are provided to the family for affixing to the individual's existing garments.

This invention may be embodied in other forms or carried out in other ways without departing from the spirit or essential characteristics thereof. The present disclosure is therefore to be considered as in all respects illustrative and not restrictive, the scope of the invention being indicated by the appended Claims, and all changes which come within the meaning and range of equivalency are intended to be embraced therein.

I claim:

1. A method for identifying lost individuals comprising the steps of:
a. Compiling a first individual data contact;
b. Entering the first individual data contact information into a computer mediated contact database;
c. Compiling a first individual tag identifier;
d. Entering the first individual tag identifier into the computer mediated contact database;
e. Relating the first individual tag identifier with the individual data contact;
f. Processing the first individual tag identifier onto image transferable media.

2. The method of claim 1, wherein the method further comprises the step of:
g. applying the image transferable media onto a garment.

3. The method of claim 1, wherein the image transferable media further comprises an RFID device.

4. The method of claim 1, wherein the first individual contact is compiled remotely through a computer connection.

5. The method of claim 1, wherein the first individual tag identifier is compiled remotely through a computer connection.

6. The method of claim 1, wherein the processing step constitutes printing the first individual tag identifier onto image transferable media.

7. The method of claim 6, wherein the printing is a photographic image of the individual.

8. The method of claim 6, wherein the printing is a computer readable image.

9. The method of claim 6, wherein the printing is a human readable image.

10. The method of claim 6, wherein the printing is performed by the end user.

11. The method of claim 1, wherein the image transferable media further comprises an embedded RFID device.

12. The method of claim 1, wherein the image transferable media further comprises an embedded GPS device.

13. The method of claim 12, wherein the GPS device is capable of transmitting position information.

14. A kit for performing the method of claim 1, wherein the kit comprises:
a. An image transferable media;
b. a first individual data contact sheet;
c. a first individual tag identifier sheet;

15. The kit of claim 14, wherein the image transferable media further comprises an RFID device.

16. The kit of claim 15, further comprising an RFID receiving device.

17. The kit of claim 14, further comprising a computer software program capable of generating a first individual tag identifier image.

18. The kit of claim 14, wherein the image transferable media further comprises a QR Code generator.

19. The method of claim 1, wherein the image transferable media further comprises at least one QR Code.

20. The method of claim 1, wherein the image transferable media further comprises a QR Code.
